(19) United States
(12) Patent Application Publication
(10) Pub. No.: US 2025/0038464 A1
(43) Pub. Date: Jan. 30, 2025

(54) WEDGE FOR TRUCK AND TRAILER ELECTRICAL COUPLING

(71) Applicant: CKLAIOWA LLC, Cedar Rapids, IA (US)

(72) Inventor: CARLTON A. SAUNDERS, JR., CEDAR RAPIDS, IA (US)

(21) Appl. No.: 18/785,963

(22) Filed: Jul. 26, 2024

Related U.S. Application Data
(60) Provisional application No. 63/529,299, filed on Jul. 27, 2023.

(51) Int. Cl. H01R 27/02; B60R 16/023

(52) U.S. Cl. CPC H01R 27/02; B60R 16/023

(57) ABSTRACT

A wedge for an electrical coupling between a pickup truck or car and trailer is designed to fit over the male plug and into the female socket of the coupling. The wedge includes a base and a collar with a tapered wall extending forwardly from the base. The collar is segmented so as to have at least two gaps therein, with a flexible finger located in at least one of the gaps. The plug extends through the wedge, so that the terminals of the plug are pushed onto the pins of the socket. Then the wedge is pushed forwardly into the socket to provide a secure friction fit of the electrical coupling components which maintain the coupling, even when the components are worn or the pickup truck or car and trailer are driven over rough roads.

### CROSS REFERENCE TO RELATED APPLICATIONS

This application claims priority under 35 U.S.C. § 119 to provisional patent application U.S. Ser. No. 63/529,299 filed Jul. 27, 2023. The provisional patent application is herein incorporated by reference in its entirety, including without limitation, the specification, claims, and abstract, as well as any figures, tables, appendices, or drawings thereof.

### TECHNICAL FIELD

The invention is directed toward a wedge and a method for securely coupling a male plug into a female socket so as to maintain functional lights on a trailer towed by a pickup truck or car.

### BACKGROUND

Trailers which are towed by a pickup truck or car typically include lights, such as brake lights, turning signal lights, and running lights, which are electrically coupled to the pickup truck or car by a male plug inserted into a female socket. A good electrical connection between the plug and the socket may deteriorate over time. For example, the plug may become loose in the socket over time due to normal wear, or may loosen over rough and bumpy roads. A loose connection may cause electrical shorts, and loss of functionality of the lights on the trailer, which creates a road hazard, both during the day and at night, if the trailer lights are not operating.

Accordingly, a primary objective of the present invention is the provision of a wedge to provide a tight fit between the plug and socket of the electrical connection for a pickup truck or car and trailer combination.

Another objective of the present invention is the provision of a method of securely connecting a male plug into a female socket of the wiring harness between a pickup truck or car and trailer.

Another objective of the present invention is the provision of a wedge for a male plug inserted into a female socket to provide an electrical coupling, wherein the wedge includes a flexible finger to enhance the friction fit between the plug and the socket.

A further objective of the present invention is the provision of a wedge for use on an electrical plug of a wiring harness, wherein the plug extends through the wedge for a secure electrical connection between terminals on the plug and pins in a female socket.

Yet another objective of the present invention is the provision of a wedge for a plug and socket electrical coupler, when the wedge has first and second, spaced apart collar portions to provide a pressure fit of the plug into the receptacle.

These and other objectives will become apparent from the following description of the invention.

### SUMMARY

The A wedge is provided for use on an electrical coupling between a pickup truck or car and a trailer. The electrical coupling includes a female socket with pins and a male plug with receptacles which are pushed onto the pins. Normally, the female socket is on the pickup truck or car and the male plug is on the trailer, though this configuration can be reversed. The wedge includes a base with an upstanding hollow collar extending from the base. The collar has open forward and rearward ends and has a height shorter than the plug, such that when the collar is mounted on the plug, the plug extends completely through the collar, from the rear end to the forward end and beyond the forward end of the wedge. The collar includes spaced apart portions which define at least two gaps in the collar. A curved, flexible finger resides in at least one of the gaps. The wedge is mounted on the plug, and then the plug is pushed into the female socket so that the pins are received in the terminals of the plug. The wedge is then pushed forwardly along the plug into the socket to provide a pressure or friction fit between the plug, the wedge, and the socket. The flexible finger enhances the friction fit, thereby providing a secure connection between the plug and the socket which will not vibrate loose, and which will accommodate wear on the plug and/or the socket.

In the wedging method for the electrical coupling, the wedge is pushed onto the male plug so that the plug extends beyond the wedge, and then the plug is pushed into the female socket to connect the pins and terminals. Then, the wedge is pushed in the female socket to create a snug fit between the plug and the socket. The wedge can be pushed further into the socket when the fit between the male plug and female socket loosens.

### BRIEF DESCRIPTION OF THE DRAWINGS

FIG. 1A is an exploded view of the electrical harness with a female socket, a male plug, and the wedge of the present invention.

FIG. 1B is a sketch showing the wedge in position on the male plug, before the plug is pushed into the female socket.

FIG. 1C is a sketch showing the plug, the wedge, and the female socket assembled for the friction fit electrical connection provided by the wedge for the plug and socket.

FIG. 2 is a perspective view of the wedge from a forward end of the wedge.

FIG. 3 is another forward end perspective view of the wedge.

FIG. 4 is a side elevation view of the wedge as shown in FIGS. 1 and 2.

FIG. 5 is another side elevation view of the wedge, from the opposite side as shown in FIG. 4.

FIG. 6 is another side elevation view of the wedge, taken at 90° from the view shown in FIG. 5.

FIG. 7 is another side elevation view of the wedge from the opposite side as shown in FIG. 6.

FIG. 8 is a top plan view of the wedge.

FIG. 9 is a bottom plan view of the wedge.

FIG. 10 is a sectional view of the wedge along lines 10-10 of FIG. 2.

FIG. 11 is another sectional view of the wedge, taken along lines 11-11 of FIG. 2.

### DETAILED DESCRIPTION

The wedge of the present invention is generally designated by the reference numeral 10 in the drawings. The wedge is intended for use on the wiring harness of a pickup truck or car 12 and trailer (not shown), wherein the harness includes a male plug 16 with terminals and a female socket 18 or receptacle with pins adapted to be matingly received in the terminals of the plug 16, thereby providing an electrical connection between the pickup truck or car and trailer. The electrical coupling between the pickup truck or car 12 in the trailer provides electricity to the trailer lights, such as brake lights, turn signal lights, and running lights.

Normally, the plug 16 is on the trailer, and the socket 18 is on the pickup truck or car 12, though these components can be reversed without affecting the wedge 10.

The wedge 10 includes a base 20 and upstanding collar 22 comprising spaced apart collar segments or walls 24A, 24B. Gaps 26, 28 exist in the collar 22, between the ends of the collar segments 24A, 24B. A flexible finger 30 exists in at least one of the gaps 26, 28. In the drawings, the finger 30 curves radially outwardly from the base 20, and then radially inwardly adjacent the upper edge of the collar segments 24A, 24B. The collar 22 may include more than two segments and more than two gaps. Also, additional flexible fingers, similar to finger 30, may be provided in other ones of the gaps.

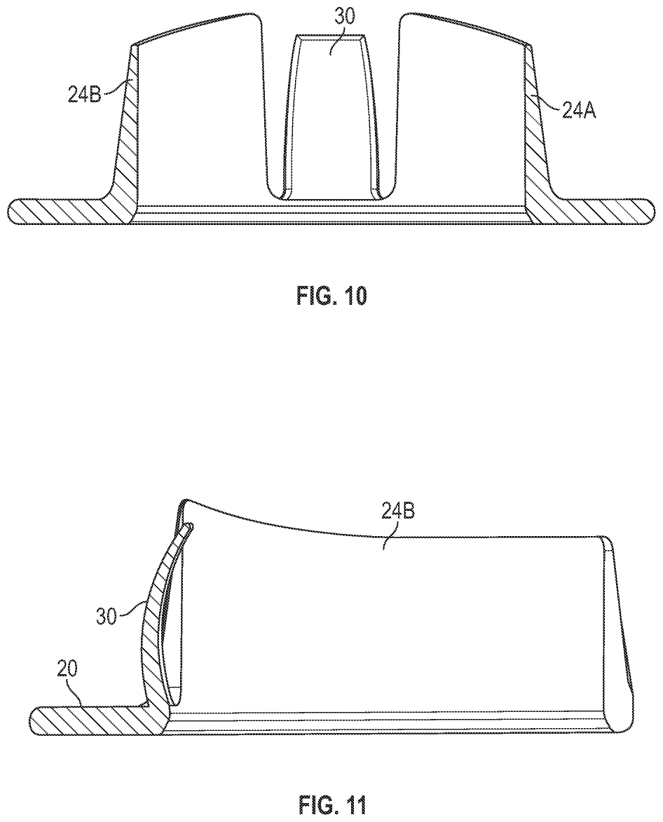

As seen in FIG. 10, the collar segments 24A, 24B are tapered from the rear end adjacent the base 20 to the top edge. This tapered configuration of the collar wall further enhances the ability to push the seam 10 into the socket 18 for improved pressure fit for the plug 16, wedge 10, and socket 18.

More particularly, the upper edge of the collar segments 24A, 24B is higher adjacent the gap 28 than at the gap 26. In other words, the upper edge of the collar segments 24A, 24B may slope or curve upwardly between the opposite ends, between the gaps 26, 28. The increased height of a portion of the collar 22 may be located anywhere along the perimeter of the collar 22, and does not have to be adjacent the gap 28. This sloped forward or upper end of the collar 22 allows the collar to begin sliding into the female socket at the highest or longest portion of the collar 22, rather than having a flat upper edge extending 360° around the collar, which would necessarily have to insert into the socket simultaneously.

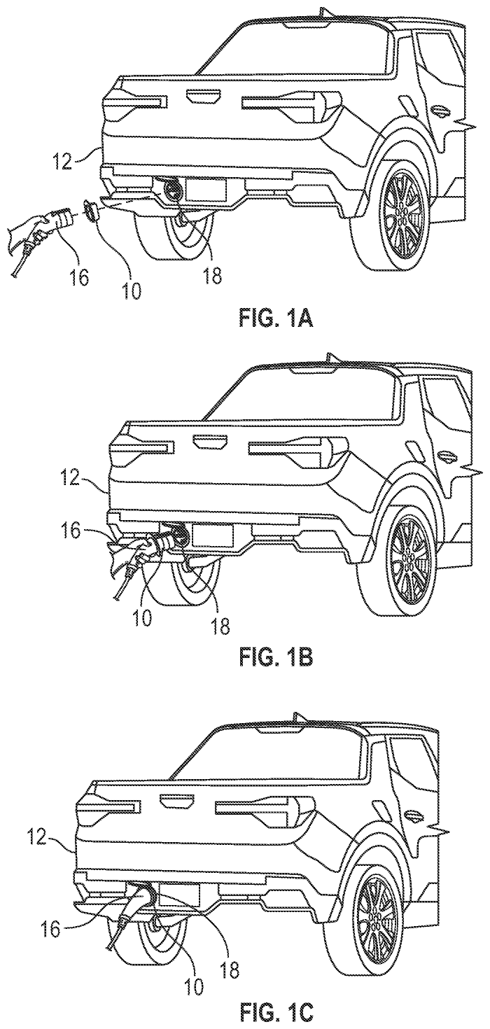

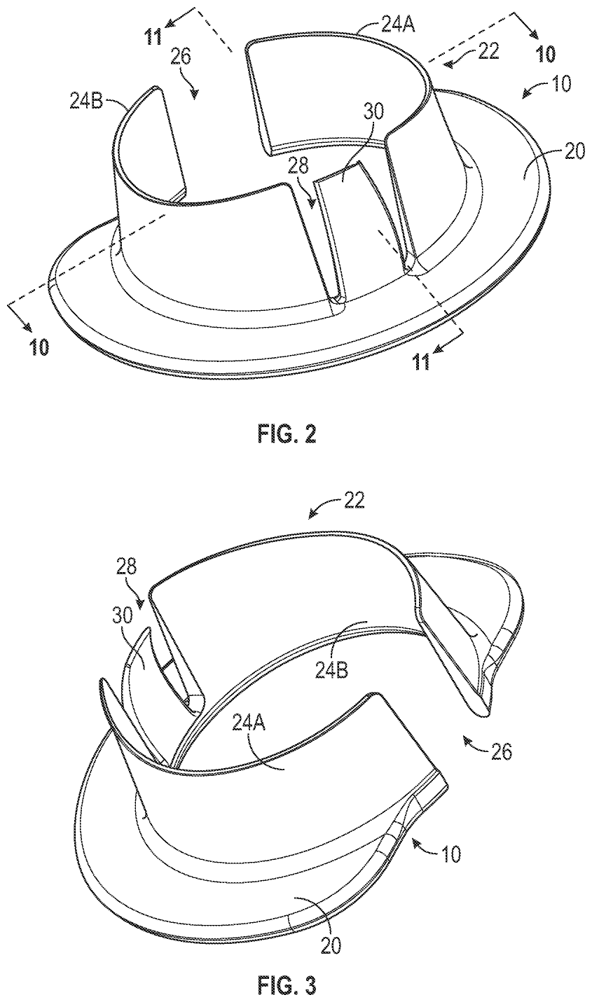

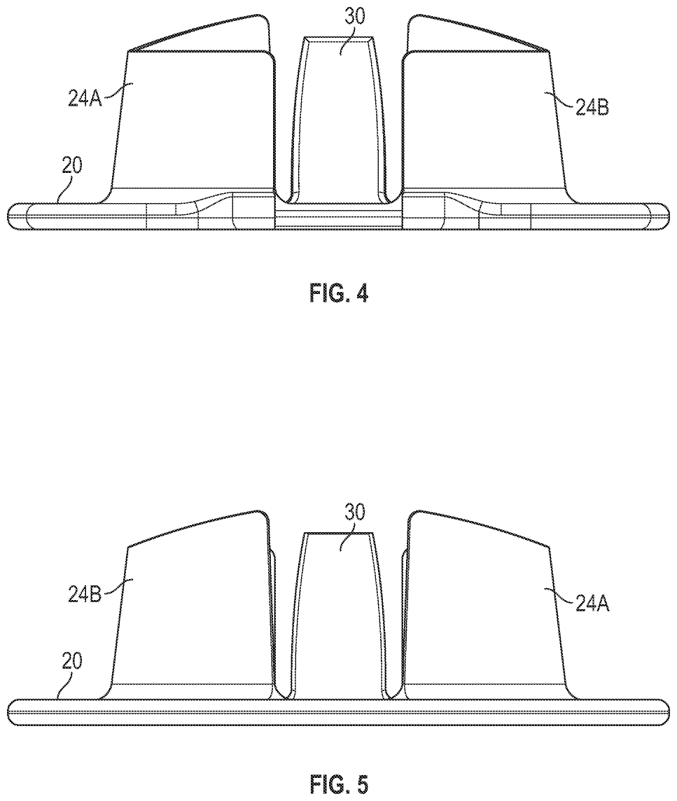

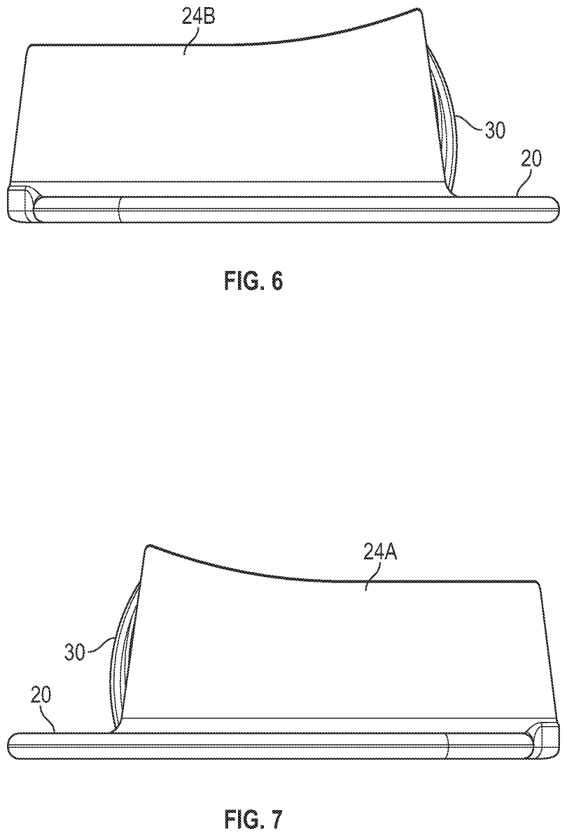

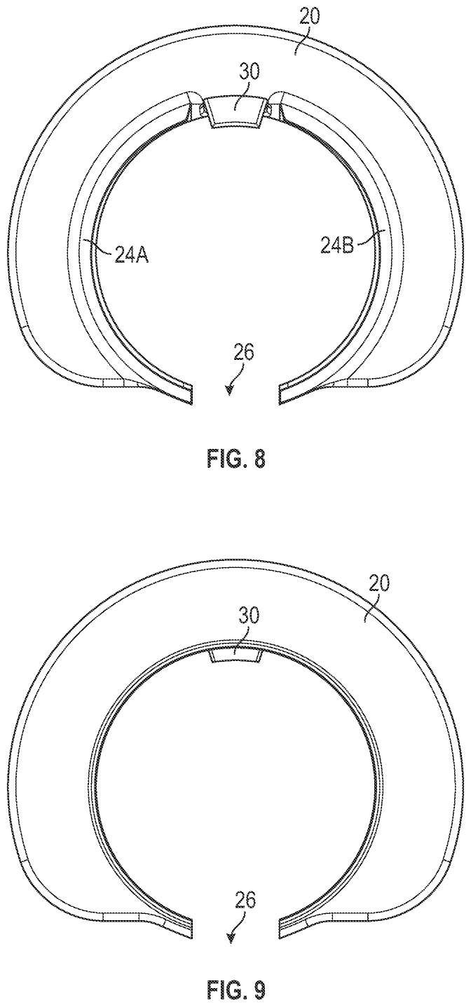

In the method of wedging and electrical coupling between a pickup truck or car and trailer according to the present invention, the wedge 10 is placed over the male plug 16 and pushed fully towards the rear end of the plug adjacent the base 20, as best seen in FIG. 1B. Then, the end of the plug 16, which extend beyond the wedge 10, is inserted into the female socket 18 until the plug is fully seated in the socket such that the socket pins (not shown) are seated into the plug terminals (not shown). Then, the wedge 10 is pushed forwardly along the plug 16 and into the female socket 18 so as to increase the friction and provide a snug fit between the plug 16 in the socket 18. The flexible finger 30 enhances the radial pressure between the wall of the socket 18 and the exterior surface of the wedge 10 so as to maintain the secure fit of the plug 16 in the socket 18. Over time, additional wear to either or both of the plug 16 and/or the socket 18, the wedge can be pushed further into the socket 18 so as to further enhance the press fit between the plug 16 and socket 18.

The collar wall is preferably tapered from the rear end toward the forward end, as seen in FIG. 10.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

What is claimed is:

1. A wedge for an electrical coupling between a pickup truck or car and a trailer, the electrical coupling including a female socket on the pickup truck or car and a male plug extending from the trailer, the wedge comprising:
a base;
a hollow collar having open forward and rearward ends and extending forwardly from the base;
the collar being split on opposite sides to define a pair of gaps in the collar;
a flexible finger residing in one of the gaps; and
the collar being adapted to fit around the male plug and into the female socket to provide a snug fit between the male plug and the female socket.

2. The wedge of claim 1 wherein the collar has a length less than the male plug's length.

3. The wedge of claim 1 wherein the collar is shorter than the plug.

4. The wedge of claim 1 wherein the base extends radially outwardly from the collar.

5. The wedge of claim 4 wherein the base extends behind the finger.

6. The wedge of claim 1 wherein the base extends approximately 90° from the collar.

7. The wedge of claim 1 wherein the base extends across one of the gaps.

8. The wedge of claim 7 wherein the base does not extend across the other of the gaps.

9. The wedge of claim 1 wherein the base and the collar are formed as one piece.

10. The wedge of claim 1 wherein the collar is tapered radially inwardly from the rearward end to the forward end.

11. A wedge for an electrical coupling between a pickup truck or car and a trailer, the electrical coupling including a female socket and a male plug, the wedge comprising:
first and second spaced apart semi-circular collar portions having forward and rearward ends;
the first and second collar portions forming a hole for receiving the male plug, and having a length shorter than the male plug; and
the first and second collar portions having an exterior diameter sized to fit into the female socket so as to provide a friction fit between the male plug and the female socket.

12. The wedge of claim 11 further comprising a flexible finger between the first and second collar portions and adapted to engage with the female socket when the male plug is inserted into the female socket.

13. The wedge of claim 11 wherein the first and second collar portions have a tapered diameter from front to back.

14. The wedge of claim 13 wherein the first and second collar portions have sloped forward edges.

15. The wedge of claim 11 further comprising a base surrounding the first and second collar portions.

16. The wedge of claim 15 wherein the base extends substantially perpendicular to the first and second collar portions.

17. The wedge of claim 11 wherein the spaced apart first and second collar portions define first and second gaps between the collar portions.

18. A method of wedging an electrical coupling between a pickup truck or car and a trailer, the electrical coupling including a female socket on the pickup truck or car and a male plug extending from the trailer, the method comprising:
pushing a wedge onto the male plug such that the male plug extends beyond the wedge; then
pushing the male plug into the female socket to matingly connect terminals and pins on the male plug and in the female socket; then
pushing the wedge into the female socket until a snug fit is established between the male plug and the female socket.

19. The method of claim 18 further comprising applying a radial force to an inside surface of the female socket with a flexible finger on the wedge.

20. The method of claim 18 wherein the wedge is pushed further into the female socket when the fit between the male plug and the female socket loosens.
